(19) United States
(12) Patent Application Publication
(10) Pub. No.: US 2011/0048831 A1
(43) Pub. Date: Mar. 3, 2011

(54) STRUCTURE OF POWER DRIVEN VEHICLE

(76) Inventor: Wen Chin TSAI, Taipei City (TW)

(21) Appl. No.: 12/859,334

(22) Filed: Aug. 19, 2010

(30) Foreign Application Priority Data
Aug. 25, 2009 (TW) 098215704

(51) Int. Cl. B62K 11/00

(52) U.S. Cl. 180/219

(57) ABSTRACT

The present invention relates to a structure of power driven vehicle, which comprises a vehicle, a power unit, a sensor, an ID logger and a control unit, wherein the vehicle further comprises a handling unit having one side configured with a throttle. The said ID logger is installed in the front frame of the vehicle. The said control unit is respectively and electrically connected with the power unit, the sensor and the ID logger to provide a multi safety insurance against vehicle theft, abnormal acceleration and/or error operation of throttle by the rider or someone else.

### CROSS-REFERENCE TO RELATED APPLICATION

This non-provisional application claims priority under 35 U.S.C. §119(a) on Patent Application No. 098215704 filed in Taiwan, R.O.C. on Aug. 25, 2009, the entire contents of which are hereby incorporated by reference.

### BACKGROUND OF THE INVENTION

1. Field of the Invention

The present invention relates to a structure of power driven vehicle, which specifically comprises a combination of a vehicle, a power unit, a sensor, an ID logger and a control unit to provide a multi safety mechanism for variety of power driven vehicle and/or bikes of the same function.

2. Description of the Related Art

Prior power driven vehicle primarily comprises a vehicle and a power unit. The said power unit is installed in the frame of the vehicle to provide the power to drive the movement of vehicle.

However, those power driven vehicles are apt to move forward suddenly if the power is still on and the throttle is mistakenly operated by the driver or anyone else. It, of course, will result to a vehicle dash and quite possibly to give rise to a serious vehicle accident and damage and/or injury toward other people. From the analysis of traffic accident related to the power driven vehicle, the power is still active to move the vehicle forward when the driver left the seat. It could not absolutely protect the power driven vehicle from any accident or damage mentioned above.

### SUMMARY OF THE INVENTION

The present invention relates to a structure of power driven vehicle, which specifically comprises a combination of a vehicle, a power unit, a sensor, an ID logger and a control unit. The said control unit is electrically connected with the power unit, the sensor and the ID logger. The handling unit is installed at the front frame of the vehicle to control the movement. And, there is a throttle configured at one side of the handling unit to control the power output and acceleration of the vehicle. As the driver is sitting on the seat, the sensor can detect the weight of the driver and the vehicle is under command and ready to start. Meanwhile, the ID logger will check the driver's identification. The vehicle will accept the control of the throttle and force the vehicle moving forward as soon as both check of the sensor and the ID logger are positive without error.

Therefore, the main objective of the present invention is to provide a structure of power driven vehicle which provides an embodiment of better vehicle safety by the combination the sensor installed under the sear to detect the driver's weight, and the ID logger to confirm the right driver status. It reduces any accident of vehicle dash or power surge caused by careless or wrong operation of throttle

Another objective of the present invention is to provide the vehicle with a better anti-theft mechanism. Except the right or the legitimate driver, there is no one can operate this power driven vehicle. Even this vehicle is lost, anyone without passing the status check could not drive this vehicle. Thus, this vehicle will not be a target among those theft cases.

In short, the present invention provides a multi function for a power driven vehicle such as safety control, anti-proof and also a worldwide popular trend of reducing the exhaust of carbon dioxide.

### BRIEF DESCRIPTION OF THE DRAWINGS

FIG. 1 illustrates a three dimensional appearance of the embodiment of the present invention.

FIG. 2 illustrates a schematic flowchart of function operated by the present invention.

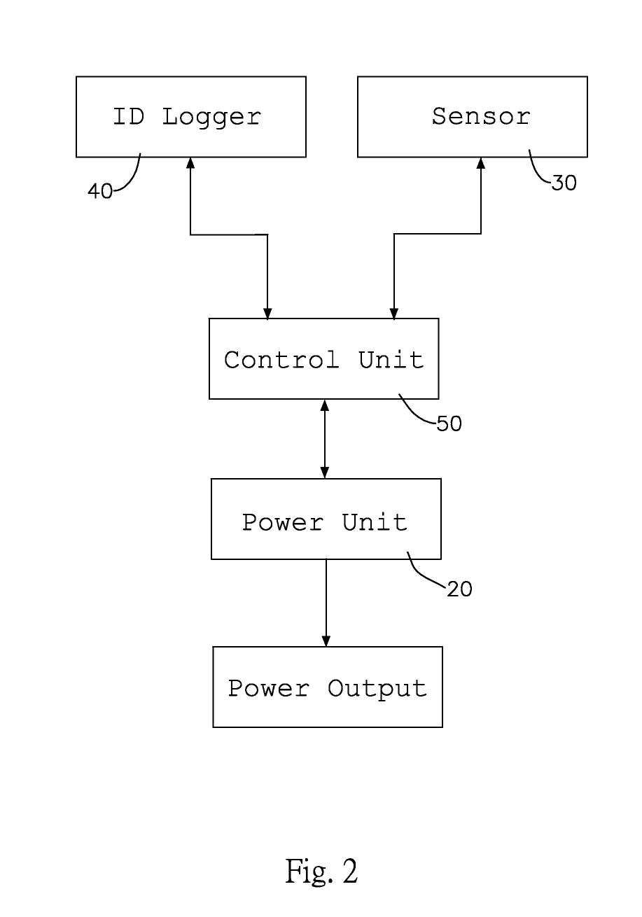

FIG. 3 illustrates the practical application of the embodiment of the present invention.

### DETAILED DESCRIPTION

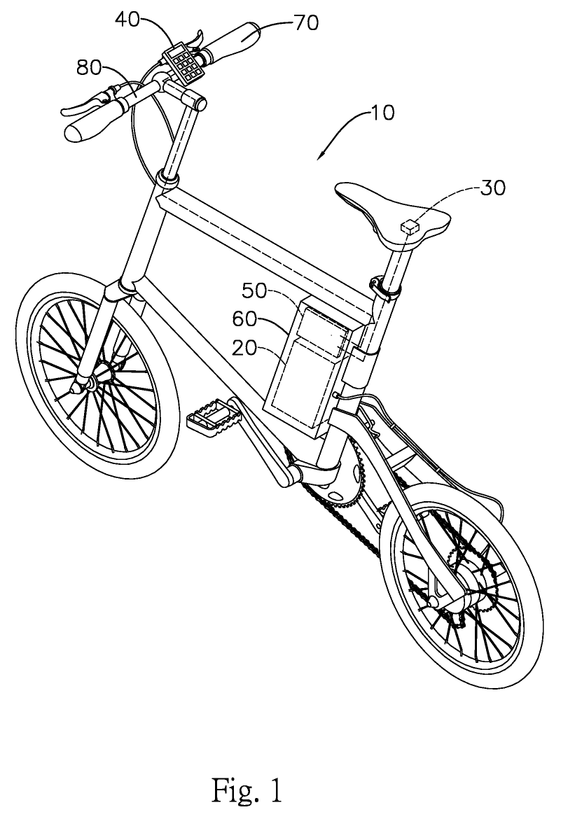

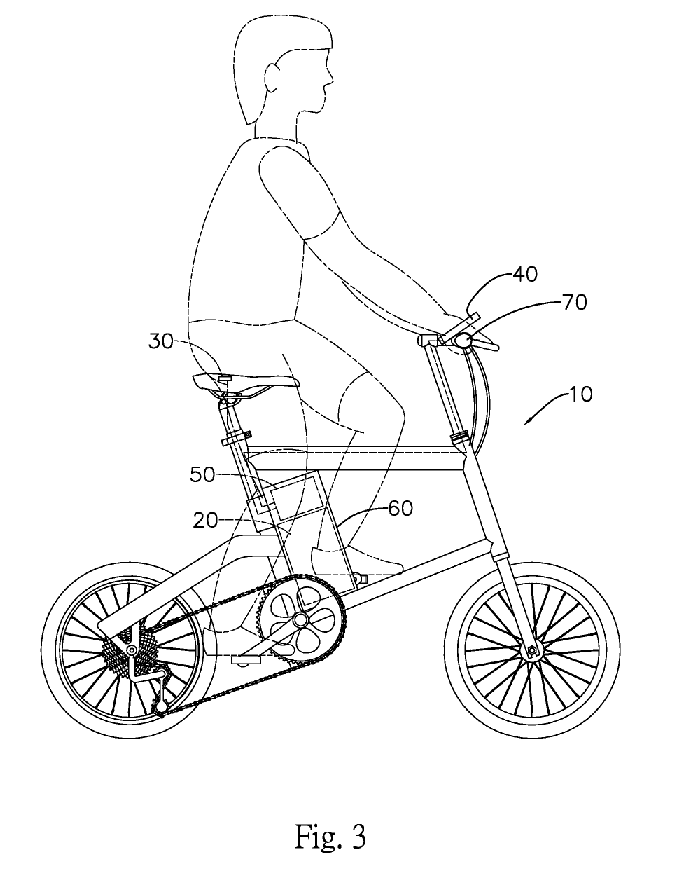

Please refer from the FIG. 1 to the FIG. 3. The present invention relates to a structure of power driven vehicle, which comprises

A vehicle 10, which further comprises a handling unit 80 configured at the front frame of the vehicle 10 to control the direction of the movement. And, there is a throttle 70 installed at one side of the handling unit 80 to perform the power output and the acceleration of the vehicle.

A power unit 20, which is installed in the frame of the vehicle 10 and output the power according to the operation from the throttle 70 to drive the movement.

A sensor 30, which is installed inside the driver seat and can detect the weight above to make sure the vehicle is under command and ready to start. The scale of detecting weight could be adjustable to fit the practicability of different drivers.

An ID logger 40, which is configured at the front side of the vehicle and works as a status guard to check the driver identification. The ID logger 40 could be a push-button keypad for entering the password or a RF ID (Radio Frequency Identification) sensing device.

A control unit 50, which is respectively and electrically connected with the power unit 20, the sensor 30 and the ID logger 40. The control unit 50 and said power unit 20 are both further configured within a casing 60.

Via the combination of those components described above, the present invention provides a structure of power driven vehicle 10 which performs a better maneuvering safety, security against theft and also a global trend of environmental protection.

Either the driver seat is empty or the weight is under the sensing scale, the sensor 30 will regard it as there is no driver ready to control the power driven vehicle 10. Under such a circumstance, the power output is interrupted no matter which position the throttle 70 is twisted. Before starting the power driven vehicle 10, the driver also needs to enter the correct password or pass the RF ID status check. Finally, the power outputs at a normal condition by the vehicle 10 control. Especially, when it comes to a traffic accident during driving, the output power will be interrupted immediately as soon as the driver leaves the seat or the weight becomes under the sensing scale. This is an alternative safety function of the present invention.

To sum up, a structure of power driven vehicle of the present invention can effectively provide a better solution and function of the prior art applied in the power driven vehicle. However, the above mentioned description are only a better embodiment of the present invention which shall not be used to limit the scope of the present invention and any equivalent change or revision based on the current invention should all be included in this invention.

What is claimed is:

1. A structure of power driven bike, comprising
a vehicle, which is further comprising a handling unit having one side configured with a throttle ;
a power unit, which is installed in the frame of the vehicle ;
a sensor, which is installed inside the driver seat on the vehicle ;
an ID logger, which is configured with the front frame of the vehicle ; and
a control unit, which is electrically connected with the power unit, the sensor and the ID logger mentioned above.

2. A structure of power driven bike according to claim 1, wherein the power unit and the control unit are further installed inside a casing.

3. A structure of power driven bike according to claim 1, wherein the ID logger is a push-button keypad.

4. A structure of power driven bike according to claim 1, wherein the ID logger is a RF ID sensing device.

5. A structure of power driven bike according to claim 1, wherein the sensor is adjustable with different sensing scale.
